(19) United States
(12) Patent Application Publication
(10) Pub. No.: US 2005/0177617 A1
(43) Pub. Date: Aug. 11, 2005

(54) Conflict resolution during data synchronization

(75) Inventors: Rajesh P. Banginwar, Hillsboro, OR (US); Jonathan A. Gitlin, Hillsboro, OR (US)

Correspondence Address: VENABLE LLP, P.O. BOX 34385, WASHINGTON, DC, 20045-9998, US

(73) Assignee: Intel Corporation, Santa Clara, CA (US)

(21) Appl. No.: 10/743,049

(22) Filed: Dec. 23, 2003

(51) Int. Cl. G06F 15/16

(52) U.S. Cl. 709/203

(57) ABSTRACT

Conflict resolution during data synchronization may be improved by sending an update version along with a synchronization request to a user having previously received a different update version from the user.

### BACKGROUND OF THE INVENTION

Users of mobile devices such as, e.g., but not limited to, desktop, handheld, tablet, subnotebook, notebook, and laptop personal computers (PCs), personal digital assistants (PDAs), and other personal information manager (PIM) devices, etc., need to synchronize data on the mobile device with data on some other device having access to a master data storage. The master data storage may reside on a desktop computer, or other device. For example, the master data storage may also reside on a remote data server such as, e.g., (but not limited to) a mail server such as MICROSOFT® EXCHANGE SERVER®, available from Microsoft Corporation of Redmond, Wash., U.S.A. The mobile device (referred to herein as a “client device” or “client”) may be coupled with another computing device (referred to as “server device” or “server”) having access to the master data storage to synchronize local data with remote data such as, e.g., (but not limited to) PIM data on the master data storage. For example, a user could be a business professional who might be updating a customer's information such as an address on the professional's client PDA. While the customer's address information is updated on the storage of the client, the information on the server's master data storage is different, i.e., unchanged, or possibly updated in a different way by a desktop computer or other device. When the professional begins the synchronization procedure between the professional's client and the server's master data storage, a conflict will be detected between the two different versions of the customer information.

Some conventional synchronization solutions may require an immediate decision from a user to resolve a conflict.

Conventional synchronization and conflict resolution processes may require relatively large amounts of data to be transferred between a client device and server device. If the communications connection between the client and server devices is wireless, the synchronization process may fail due to the time it takes to transfer the data over the transient, intermittent, potentially unstable wireless connection.

### BRIEF DESCRIPTION OF THE DRAWINGS

Various exemplary features and advantages of the invention will be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of a client device and server device synchronization conflict resolution system according to an exemplary embodiment of the present invention;

FIG. 2 depicts an exemplary embodiment of a diagram illustrating an exemplary non-time sensitive process of synchronization conflict resolution according to an exemplary embodiment of the present invention;

FIG. 3 depicts an exemplary embodiment of a client device illustrating a user interface enabling a user to specify which versions of a synchronization item should be kept to resolve a conflict identified during synchronization according to an exemplary embodiment of the present invention; and

FIG. 4 depicts an exemplary embodiment of a computer system that may be used in the target or source devices according to an exemplary embodiment of the present invention.

### DETAILED DESCRIPTION OF EXEMPLARY EMBODIMENTS OF THE PRESENT INVENTION

A preferred exemplary embodiment of the invention is discussed in detail below. While specific exemplary embodiments are discussed, it should be understood that this is done for illustration purposes only. A person skilled in the relevant art will recognize that other components and configurations may be used without parting from the spirit and scope of the invention.

In an exemplary embodiment of the present invention an update of a synchronization item (sync item) from a client device may be sent to a server device able to access a master data storage (MDS). In the exemplary embodiment, when the server device detects a conflict between versions of the synchronization item, the server may send the server's version of the updated record along with a conflict resolution request from the server to the client. The user at the client, at what may be a later time, may resolve the conflict by sending from the client to the server the user's choice as to which version of the synchronization item the user wishes to keep. Both client and server devices may then resolve the conflict accordingly. The exemplary embodiment minimizes the amount of data transferred between the server device coupled to the master data storage and the mobile client device in synchronizing with the master data storage. Data transfer may occur over an intermittent wireless connection. The synchronization process of the exemplary embodiment may be insensitive to time, since the process may allow synchronization to be completed independently of conflict resolution. The conflict resolution process of the exemplary embodiment may include a series of separate actions that may not occur immediately after one another, but may occur at a later time following the completion of synchronization. The process also need not require copies of server applications on client devices.

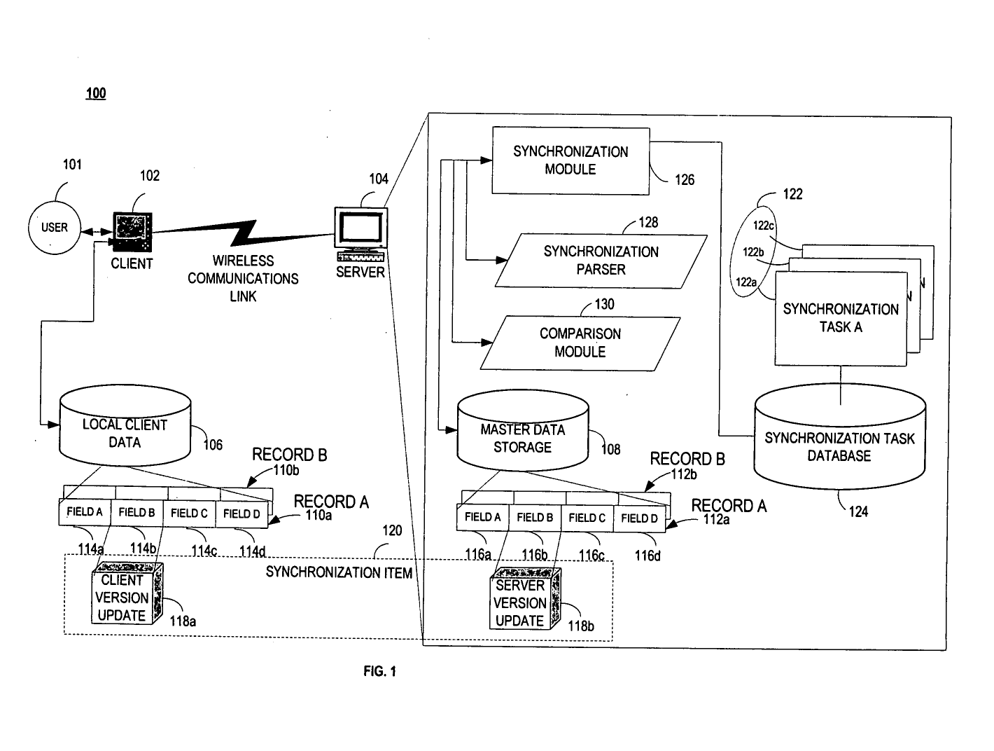

FIG. 1 depicts an exemplary embodiment of a synchronization conflict resolution system environment 100 that may allow a user 101 to resolve a conflict according to an exemplary embodiment of the invention. The system environment 100 may include a client device 102 and a server device 104 according to an exemplary embodiment of the present invention. In an exemplary embodiment, the client device 102 may be coupled to server device 104 by, e.g., (but not limited to) a communications link such as, e.g., (but not limited to) a wireless link, or by a direct connection or coupling such as, e.g., (but not limited to) a docking station, an RS-232 serial interface, a universal serial bus (USB) connection, or other bus, etc. The client device 102 may include client data 106 that may correspond to a master data storage 108, that may be accessible to server device 104. The master data storage 108 may be a local database of server device 104, or may be accessible via a remote data server accessible over a communications connection such as, e.g., but not limited to, a local area network (LAN) or wide area network (WAN). As shown in an exemplary embodiment, client data 106 may include one or more data records 110a and 110b. Each data record 110a, 110b may include one or more data fields 114a, 114b, 114c, and 114d. The master data storage 108 may similarly include one or more data records 112a and 112b, corresponding to data records 110a and 110b, respectively, of client device 102. Each data record 112a, 112b may include one or more data fields 116a, 116b, 116c, and 116d corresponding to data fields 114a, 114b, 114c and 114d respectively, of client device 102.

A conflict may arise, e.g., (but not limited to) when one or more data fields 114a, 114b, 114c and 114d of client device 102 are updated in one way, and the corresponding one or more fields 116a-d of server device 104 are updated in another way. Of course, conflicts may also arise by an update of a data field 114, 116 of either the client device 102, or server device 104, without a corresponding update on the other device. In FIG. 1, a client version update 118a is shown conflicting with a server version update 118b, in an exemplary embodiment of a conflict arising as a synchronization item 120. A synchronization item 120 may be any item of data that may be maintained on both the master data storage 108 and one or more mobile devices clients 102 and may be synchronized among devices 102, 104 of user 101. Exemplary synchronization items 120 may include, e.g., (but not limited to) a contact record, a calendar entry, a task list item, an e-mail message, an expense record, and a note, etc. respectively (but are not limited thereto).

Synchronization item (sync item) 120 may be one of various synchronization tasks 122 that may be stored in a synchronization database 124. Synchronization tasks 122 and synchronization items 120 may be performed by a synchronization module 126 that may be executed by a computer such as, e.g., server 104. Exemplary synchronization tasks may include, e.g., but are not limited to, a contact list, a calendar, a task list, an email mailbox, an expense report, and a notebook, etc. Conflicts between different versions of updates 118a, 118b of synchronization items 120 may need to be resolved. Synchronization module 126, in an exemplary embodiment of the present invention, may use a synchronization parser module 128 to parse out synchronization items 120 from an exemplary synchronization task 122, and then may use a comparison module 130 to identify conflicts needing resolution.

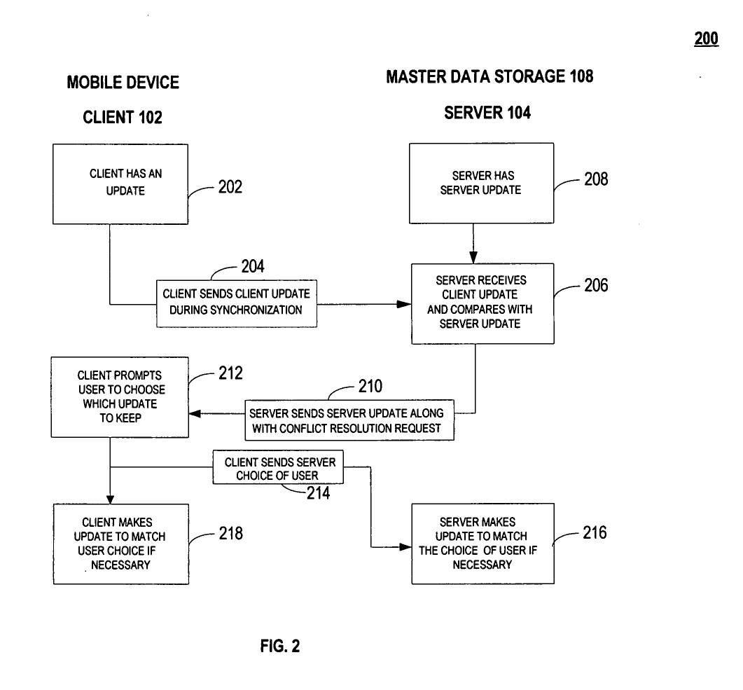

FIG. 2 depicts an exemplary embodiment of a diagram 200 illustrating an exemplary process of synchronization conflict resolution between client and server version updates that may be not time sensitive according to an exemplary embodiment of the present invention. The following description may also refer to elements shown in FIG. 1, discussed above. FIG. 2 illustrates an exemplary embodiment of a method of resolving a synchronization conflict between client version update 118a of data on client device 102 and server version update 118b of data on server 104. An exemplary embodiment may presume an environment where the client device 102 may be a mobile device, which has data to be synchronized with the master data storage 108 accessible by server 104, which in the exemplary embodiment may be a desktop computer.

Synchronization may be initiated by a synchronization request. A synchronization request may include, e.g., but is not limited to, a request to synchronize synchronization items and/or synchronization tasks. A synchronization request may be initiated by, e.g., but not limited to, a user. Alternatively, synchronization may be initiated otherwise, such as, e.g., but not limited to, upon a synchronization request by a server, client, or other device, upon the client and server coming within range of one another, upon a periodic process, upon scheduled intervals, as a result of a polling process, upon coupling the client 102 to the server 104, etc. Generally, synchronization then may proceed to synchronize synchronization items (sync items) using an algorithm such as, e.g., but not limited to, an algorithm identifying for every synchronization task, any updated sync items and identifying and replacing non-updated versions of the sync item. Synchronization may continue until all respective sync items have been synchronized. Once no other sync items remain to be synchronized, then synchronization is complete. If, e.g., but not limited to, both a client update version and a server update version may exist, then a conflict may exist and the conflict between the two versions of the update may need to be resolved by having the user select which version of the updates to keep.

Diagram 200 may begin with 202, where the mobile device client 102 has a client version update 118a (also referred to simply as client update 118a) for a synchronization item 120. The diagram may proceed from 202 to 204.

In 204, client 102 may be coupled to server 104 and may be further coupled to master data storage 108. In 204, the client 102 may send the client version update 118a to the server 104 for comparison with a version of the update on the master data storage 108 during synchronization. In an exemplary embodiment, client 102 may send the client version update 118a over one or more network communication links, which may include, but are not limited to, in an exemplary embodiment, one or more wireless communication links, before ultimately reaching server 104 coupled to master data storage 108.

In the exemplary embodiment, in 208, suppose server 104 has an update to the synchronization item, i.e., a server version update 118b also referred to simply as server update 118b. The server update, or MDS update, may be provided to 206 for comparison with the incoming client update 118a. Upon receiving the client update in 206, the client update 118a may be compared to server update 118b.

In 206, the server 104, coupled to the master data storage may receive the client version update 118a, e.g., but not limited to, during synchronization, the client version update 118a received may be compared to the server version update 118b of the synchronization item 120 that may be stored in the master data storage 108. Synchronization may be performed by synchronization module 126 and may make use of synchronization parser module 128 to break up synchronization tasks 122 into individual synchronization items 120. Comparison module 130 may be used to identify conflicts between different version updates 118a, 118b of synchronization items 120.

In 210, if the two versions of the updates 118a, 118b may be found to be different, then the server 104 may send a copy of the server version update 118b of the synchronization item 120 of the master data storage 108 to the client 102, along with a conflict resolution request. The conflict resolution request may be addressed to user 101, and may not need to be responded to immediately in order to complete synchronization. Completion of synchronization may occur, e.g., but not limited to, when, e.g., but not limited to, in an exemplary embodiment, all synchronization tasks and all synchronization items of both the client and the server have been compared to one another to identify any conflicts.

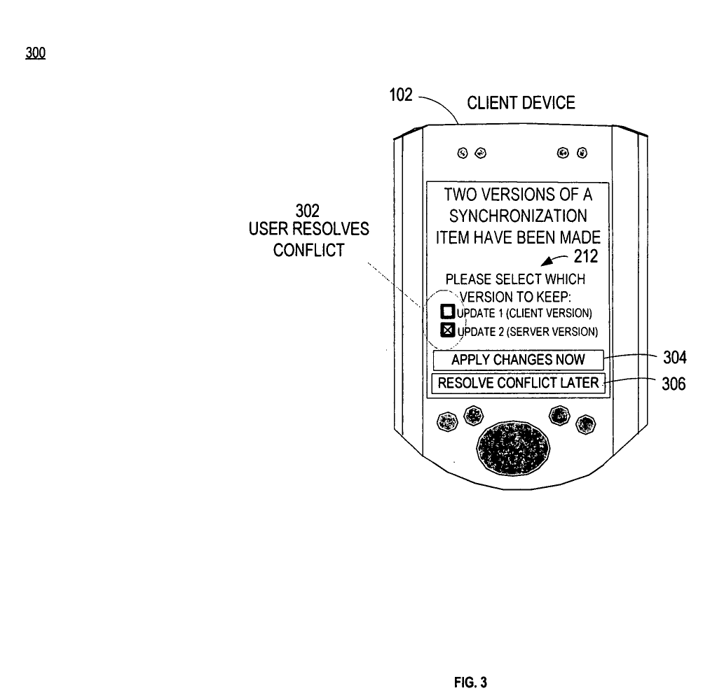

In 212, the client 102 may prompt the user 101 to choose which of the update versions 118a, 118b of the data the user 101 wants to keep, allowing user 101 to choose at a later time to keep either client version update 118a or server version update 118b to resolve the conflict (or alternatively to retain both). An example of such a prompt may be seen in FIG. 3, described further below.

In 214, at what may be a later time, the user 101 may choose the version of updates 118a, 118b to be retained, and the client 102 may send the choice of user 101 to the server 104, resolving the conflict.

In 216, if the user 101 chose the client version update 118a, then the server 104 may update the master data storage 108 to replace server version update 118b with the client version update 118a of the data of synchronization item 120 previously received from the client 102 in 206. On the other hand, if user 101 instead chose to use the server version update 118b, then the client version update 118a, previously received in 206 from the client 102, may be deleted.

In 218, if the user 101 chose the server version update 118b to resolve the conflict, then the client 102 may replace client version update 118a with the server version update 118b received in 210 from server 104 to resolve the conflict. Alternatively, if the user 101 chose the client version update 118a, then the server version update 118b previously received from server 104 in 210 may be deleted.

Additionally, in an exemplary embodiment, it may not be necessary for the conflict to be resolved during the synchronization process. The user 101 may wait until a later time to resolve the conflict by waiting until a later time to access a tool to review conflicts to resolve, and to select which of the updated versions 118a, 118b may be retained, at which point the server 104 and client 102 may be informed of the choice of user 101, and the conflict resolution process may be completed accordingly.

FIG. 3 depicts an exemplary embodiment of a view 300 of a client device 102 illustrating an exemplary user interface for a client application prompting user 101 to select which of client version update 118a, and server version update 118b to keep. In an exemplary embodiment, the user 101 may be prompted to select one of the two versions of the update 118a, 118b, using, e.g., but not limited to, selectable graphical user interface (GUI) check boxes, radio buttons 302, a menu, a stylus, or the like. In an exemplary embodiment, after the user 101 selects a version of the updates 118a, 118b, the changes may be applied by using a graphical user interface button labeled “apply changes now” 304. In an exemplary embodiment, the user 101 may defer until a later time to resolve the conflict by using a graphical user interface button labeled “resolve conflict later” 306. In one exemplary embodiment, check boxes 302 may be initially both checked to retain both versions of the synchronization item 120 until a later time.

In an exemplary embodiment, the master data storage 108 may be any device, hardware and software capable of storing and with which computing devices such as a mobile device may communicate, and that may store synchronization items 120. Some examples of the master data storage 108 may include, e.g., (but not limited to) PIM software on a desktop computer, and a remote data server such as MICROSOFT® EXCHANGE SERVER®, available from Microsoft Corporation, of Redmond, Wash., U.S.A.

It may be important to note that although in the exemplary embodiment user 101 may be described as using a device referred to as client 102 coupled to a device referred to as server 104, the client device 102 and server device 104 need not have a client/server relationship. For example, client 102 and server 104 may be similar devices and/or may communicate in a peer-to-peer manner. Alternatively, client device 102 and server device 104 may be labeled first device 102 and second device 104, respectively. Further the devices 102, 104 as described may be coupled via a communications link, or a wireless communications link. Other ways of coupling client 102 and server 104 may equally be used to accomplish communication such as, e.g., (but not limited to) a wired network connection, a local connection, a local area, wide area, or metropolitan area network connection, a community access television (CATV, or cable TV) connection, a satellite connection, a bus connection, an optical connection, a parallel or serial data bus, universal serial bus (USB) connection, or other bus, etc.

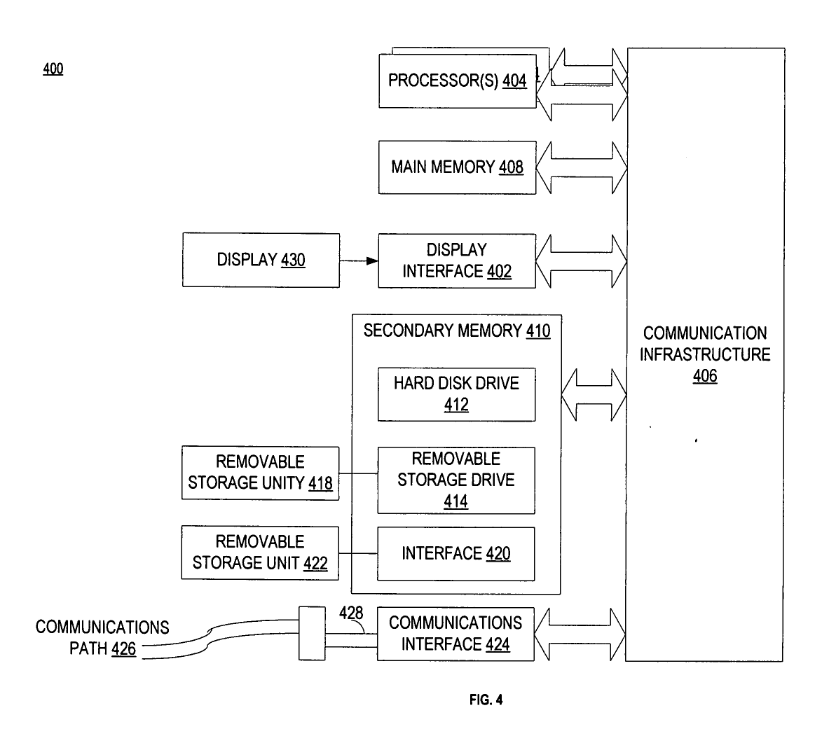

FIG. 4 depicts an exemplary embodiment of a computer system that may be used in computing devices such as, e.g., but not limited to, client or server devices according to an exemplary embodiment of the present invention. FIG. 4 depicts an exemplary embodiment of a computer system that may be used as client device 102, or a server device 104, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 400 is shown in FIG. 4, depicting an exemplary embodiment of a block diagram of an exemplary computer system useful for implementing the present invention. Specifically, FIG. 4 illustrates an example computer 400, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 400 is shown in FIG. 4. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 4.

The computer system 400 may include one or more processors, such as, e.g., but not limited to, processor(s) 404. The processor(s) 404 may be connected to a communication infrastructure 406 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 400 may include a display interface 402 that may forward, e.g., but not limited to, graphics, text, and other data, etc., from the communication infrastructure 406 (or from a frame buffer, etc., not shown) for display on the display unit 430.

The computer system 400 may also include, e.g., but may not be limited to, a main memory 408, random access memory (RAM), and a secondary memory 410, etc. The secondary memory 410 may include, for example, (but not limited to) a hard disk drive 412 and/or a removable storage drive 414, representing a floppy diskette drive, a magnetic tape drive, an optical disk drive, a compact disk drive CD-ROM, etc. The removable storage drive 414 may, e.g., but not limited to, read from and/or write to a removable storage unit 418 in a well known manner. Removable storage unit 418, also called a program storage device or a computer program product, may represent, e.g., but not limited to, a floppy disk, magnetic tape, optical disk, compact disk, etc. which may be read from and written to by removable storage drive 414. As will be appreciated, the removable storage unit 418 may include a computer usable storage medium having stored therein computer software and/or data.

In alternative exemplary embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 422 and interfaces 420, which may allow software and data to be transferred from the removable storage unit 422 to computer system 400.

Computer 400 may also include an input device such as, e.g., (but not limited to) a mouse or other pointing device such as a digitizer, and a keyboard or other data entry device (none of which are labeled).

Computer 400 may also include output devices, such as, e.g., (but not limited to) display 430, and display interface 402. Computer 400 may include input/output (I/O) devices such as, e.g., (but not limited to) communications interface 424, cable 428 and communications path 426, etc. These devices may include, e.g., but not limited to, a network interface card, and modems (neither are labeled). Communications interface 424 may allow software and data to be transferred between computer system 400 and external devices. Examples of communications interface 424 may include, e.g., but may not be limited to, a modem, a network interface (such as, e.g., an Ethernet card), a communications port, a Personal Computer Memory Card International Association (PCMCIA) slot and card, etc. Software and data transferred via communications interface 424 may be in the form of signals 428 which may be electronic, electromagnetic, optical or other signals capable of being received by communications interface 424. These signals 428 may be provided to communications interface 424 via, e.g., but not limited to, a communications path 426(e.g., but not limited to,a channel). This channel 426 may carry signals 428, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 414, a hard disk installed in hard disk drive 412, and signals 428, etc. These computer program products may provide software to computer system 400. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 408 and/or the secondary memory 410 and/or removable storage units 414, also called computer program products. Such computer programs, when executed, may enable the computer system 400 to perform the features of the present invention as discussed herein. In particular, the computer programs, when executed, may enable the processor 404 to provide a method to resolve conflicts during data synchronization according to an exemplary embodiment of the present invention. Accordingly, such computer programs may represent controllers of the computer system 400.

In another exemplary embodiment, the invention may be directed to a computer program product comprising a computer readable medium having control logic (computer software) stored therein. The control logic, when executed by the processor 404, may cause the processor 404 to perform the functions of the invention as described herein. In another exemplary embodiment where the invention may be implemented using software, the software may be stored in a computer program product and loaded into computer system 400 using, e.g., but not limited to, removable storage drive 414, hard drive 412 or communications interface 424, etc. The control logic (software), when executed by the processor 404, may cause the processor 404 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware and software, etc.

The exemplary embodiment of the present invention may make reference to wireless personal area networks. A brief discussion of various exemplary wireless network technologies that may be used to implement the embodiments of the present invention are discussed below. Exemplary wireless network types, include, e.g., but are not limited to, Bluetooth, Infrared Data Association (IrDA), shared wireless access protocol (SWAP), “wireless fidelity” (Wi-Fi), and IEEE standard 802.11 wireless local area networks (LANs) including, e.g., but not limited to, IEEE std. 802.11a, b, d and g,(including, e.g., IEEE Std 802.11, 1999 Edition; or IEEE Std 802.11a-1999, IEEE Std 802.11b-1999, IEEE Std 802.11b-1999/Cor 1-2001, IEEE Std 802.11d-2001, IEEE Std 802.11-1999 (R2003), and/or IEEE 802.11g-2003, etc.) and ultrawideband (UWB), etc.

Bluetooth is an emerging wireless technology promising to unify several wireless technologies for use in low power radio frequency (RF) networks.

IrDA is a standard method by which devices may communicate using infrared light pulses (often, but not limited to, direct line of sight) as promulgated by the Infrared Data Association from which the standard gets its name.

Examples of short-range wireless RF technologies may include, e.g., but are not limited to, shared wireless access protocol (SWAP) developed by Home radio frequency (HomeRF), and wireless fidelity (Wi-Fi), a derivative of IEEE 802.11, advocated by the wireless ethernet compatibility alliance (WECA), etc.

The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., wireless LANs compliant with IEEE std. 802.11a, b, d or g, such as, e.g., but not limited to, those noted above.

Another exemplary short-range RF wireless communication system may include UWB. UWB may use small pulses of energy in the time domain that in the frequency domain may be spread across a very wide bandwidth and may be transmitted at a very low power level that is on the order of noise. The pulses may be encoded to carry information by, e.g., but not limited to, differing the timing of arrival of pulses in the time domain, etc.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. A method, comprising:
receiving a client update of a synchronization item (sync item) from a client at a server including a master data storage (MDS);
comparing the client update of said sync item to a MDS update of said sync item;
sending a request to resolve a conflict and said MDS update to the client when the client update and said MDS update are not identical;
receiving a selection of a user in response to said request from the client noting to keep at least one of said MDS update and said client update; and
replacing said MDS update with the client update when said selection indicates to keep the client update.

2. The method of claim 1, wherein said receiving said selection occurs at least one of subsequently to said sending said request to resolve said conflict and after completion of synchronization.

3. The method of claim 1, further comprising:
receiving a synchronization request from the client at said server.

4. The method of claim 1, further comprising:
receiving a synchronization request at said server.

5. The method of claim 1, further comprising:
communicating to the client to replace the client update on the client with said MDS update when said selection indicates to keep said MDS update.

6. The method of claim 1, wherein said receiving the client update at said server comprises:
receiving the client update at at least one of a desktop computer, a personal information manager (PIM) application server, and a mail server.

7. The method of claim 1, wherein said receiving the client update comprises receiving the client update via a wireless communications network.

8. A method, comprising:
sending a client update of a synchronization item (sync item) from a client to a server coupled to a master data storage (MDS);
receiving a MDS update of said sync item and a request to resolve a conflict at said client when the MDS update and said client update of said sync item are not identical;
prompting a user to select at least one of the MDS update and said client update to keep;
receiving a selection of the user in response to said prompting noting which of at least one of the MDS update and said client update to keep;
sending said selection to the server in response to the request; and
replacing said client update with the MDS update when said selection indicates to keep the MDS update.

9. The method of claim 8, wherein said sending said client update comprises sending from a mobile device.

10. The method of claim 8, wherein said receiving said selection comprises:
receiving said selection at least one of at a later time than said receiving the request to resolve said conflict; and after completion of synchronization.

11. The method of claim 8, further comprising:
receiving a synchronization request of said sync item at said client.

12. A system, comprising:
a server coupled to a master data storage (MDS) adapted to communicate with a client, said server adapted to receive a client update of a synchronization item (sync item) from the client to compare the client update to a MDS update of said sync item, and to send a request to resolve a conflict and said MDS update to the client when the client update and said MDS update are not identical; said server adapted to receive a selection of a user as to at least one of said MDS update and the client update to keep, and to replace said MDS update with the client update when said selection indicates to keep the client update.

13. The system of claim 12, wherein at least one of the client and said server comprises a mobile device.

14. The system of claim 12, wherein said server is adapted to be coupled to the client by a wireless communications network.

15. The system of claim 12, wherein said wireless communications network comprises at least one of:
a blue tooth network;
a shared wireless access protocol (SWAP) network;
a wireless fidelity (WI-FI) network;
an 802.11 wireless local area network (WLAN); and
an ultra wideband (UWB) network.

16. A system comprising:
a client adapted to communicate with a server coupled to a master data storage (MDS), said client adapted to send a client update of a synchronization item (sync item) to the server, to receive a request to resolve a conflict and an MDS update from the server when said client update and the MDS update are determined to be not identical, to send a selection of a user as to which of at least one of said client update and the MDS update to keep, to receive said selection, and to replace said client update with the MDS update when said selection indicates to keep the MDS update.

17. The system of claim 16, wherein said client is adapted to receive a synchronization request of said sync item at said client.

18. The system of claim 16, wherein at least one of said client and the server comprises a mobile device.

19. The system of claim 16, wherein said client adapted to communicate with the server is adapted to communicate via a wireless communications network.

20. A machine-readable medium that provides instructions, which when executed by a computing platform, cause said computing platform to perform operations comprising a method of:
receiving a client update of a synchronization item (sync item) from a client at a server in communication with a master data storage (MDS);
comparing the client update of said sync item to a MDS update of said sync item;
sending a request to resolve a conflict and said MDS update to the client when the client update and said MDS update are not identical;
receiving a selection of a user in response to said request indicating which of at least one of said MDS update and the client update to keep; and
replacing said MDS update with the client update when said selection indicates to keep the client update.

21. The machine-readable medium of claim 20, wherein said receiving said selection occurs at a time comprising at least one of subsequent to said sending said request, and after completion of synchronization.

22. The machine-readable medium of claim 20, wherein the method further comprises:
receiving a synchronization request from the client at said server.

23. The machine-readable medium of claim 20, wherein the method further comprises:
receiving a synchronization request at said server.

24. The machine-readable medium of claim 20, wherein the method further comprises:
communicating to the client to replace the client update on the client with said MDS update when said selection indicates to keep said MDS update.

25. A machine-readable medium that provides instructions, which when executed by a computing platform, cause said computing platform to perform operations comprising a method of:
sending a client update of a synchronization item (sync item) from a client to a server coupled to a master data storage (MDS);
receiving a MDS update of said sync item and a request to resolve a conflict at said client when the MDS update and said client update of said sync item are not identical;
prompting a user to select at least one of the MDS update and said client update to keep;
receiving a selection of the user in response to said prompting noting which of at least one of the MDS update and said client update to keep;
sending said selection to the server in response to the request; and
replacing said client update with the MDS update when said selection indicates to keep the MDS update.

26. The machine-readable medium of claim 25 wherein said receiving said selection comprises:
receiving said selection at least one of at a later time than said receiving the request to resolve said conflict; and after completion of synchronization.

27. The machine-readable medium of claim 25 wherein the method further comprises:
receiving a synchronization request of said sync item at said client.
